(19) United States
(12) Patent Application Publication
(10) Pub. No.: US 2015/0112562 A1
(43) Pub. Date: Apr. 23, 2015

(54) METHOD FOR CONTROLLING A CLUTCH START AFTER AN ENGINE STOP COASTING PHASE OF A MOTOR VEHICLE

(71) Applicant: Robert Bosch GmbH, Stuttgart (DE)

(72) Inventor: Frank BAST, Asperg (DE)

(21) Appl. No.: 14/521,611

(22) Filed: Oct. 23, 2014

(30) Foreign Application Priority Data
Oct. 23, 2013 (DE) 10 2013 221 479.0

(51) Int. Cl. F02N 11/00; F16D 48/06; B60W 10/06; B60W 10/02

(52) U.S. Cl. CPC F02N 11/00; B60W 10/02; F16D 48/06; B60W 10/06
USPC 701/68; 477/167

(57) ABSTRACT

A method for controlling a clutch start after an engine stop coasting phase of a motor vehicle whose service brake is applied and whose braking system may be influenced by a clutch control with regard to the braking torque. In this connection, the braking torque is reduced by the value caused by the clutch start as an effective wheel torque by engaging the clutch. This has the advantage that the exact amount of braking effect is achieved, which was intended by the original application of the brake without a clutch start. Consequently, no additional braking effect results from the clutch start, which would reduce the comfort of the passengers. The passengers namely perceive a clutch start as the application of the brake.

### FIELD OF THE INVENTION

The present invention relates to a method for controlling a clutch start after an engine stop coasting phase of a motor vehicle whose service brake is applied and whose braking system may be influenced by a clutch control with regard to the braking torque. Furthermore, the present invention relates to a computer program which carries out all steps of the method according to the present invention when it is run on a computing device, as well as a data medium which stores this computer program. Finally, the present invention relates to a control unit which is designed for carrying out the method according to the present invention.

### BACKGROUND INFORMATION

Motor vehicles having automated clutch systems which are equipped with a coasting function are part of the related art. In this connection, an internal combustion engine may be switched off during coasting, since the drive train is interrupted. Under certain general conditions, coasting is stopped or the internal combustion engine is restarted via a so-called clutch or pull start. In this connection, the internal combustion engine is set in rotational motion by engaging the automated clutch. The clutch start replaces the function of the starter. The energy required for the clutch start of the internal combustion engine is supplied by the kinetic energy of the vehicle, which may result in a vehicle acceleration curve which reduces passenger comfort. The passengers perceive the clutch start as a brief application of the service brake.

German Published Patent Application No. 10 2010 031 036 A1 describes a method in which a motor vehicle is initially in coasting mode, i.e., the drive train is interrupted and the engine is not able to participate in braking. When the brake is applied, the coasting phase is interrupted in order to be able to also utilize the braking effect of the engine. This makes it possible to achieve the maximum braking effect.

### SUMMARY

The present invention relates to a method for controlling a clutch start after an engine stop coasting phase of a motor vehicle whose service brake is applied and whose braking system may be influenced by a clutch control with regard to the braking torque. In this connection, the braking torque is reduced by the value of a clutch torque having a braking effect which the clutch start causes as an effective wheel torque by engaging the clutch. This has the advantage that the exact amount of braking effect is achieved, which was intended by the original application of the brake without a clutch start. Consequently, no additional braking effect results from the clutch start, which would reduce the comfort of the passengers. The passengers namely perceive a clutch start as the application of the brake.

Preferably, the braking system is equipped with an ABS and/or an ESP system. An ABS and/or an ESP system make(s) it possible for the clutch control to influence the braking system of a motor vehicle with regard to the braking torque.

Preferably, the value of the clutch torque having a braking effect is calculated by the clutch control and transferred to a device which coordinates a brake intervention. It is particularly preferred that the device is an ABS and/or ESP control unit. As mentioned above, these systems make it possible for the braking torque of a motor vehicle to be influenced by its clutch control.

The computer program according to the present invention makes it possible to implement the method according to the present invention in an existing control unit without the necessity of structurally altering it. For this purpose, it carries out all steps of a method according to the present invention when it is run on a computing device or a control unit. The data medium according to the present invention stores the computer program according to the present invention. By installing the computer program according to the present invention on a control unit, the control unit according to the present invention is obtained, which is designed for controlling a clutch start of a motor vehicle according to the method of the present invention.

### BRIEF DESCRIPTION OF THE DRAWINGS

FIG. 1 shows a wheel torque-time diagram of a clutch start while the service brake according to the related art is applied simultaneously.

FIG. 2 shows a wheel torque-time diagram of a clutch start while the service brake is applied simultaneously in one specific embodiment of the method according to the present invention.

### DETAILED DESCRIPTION

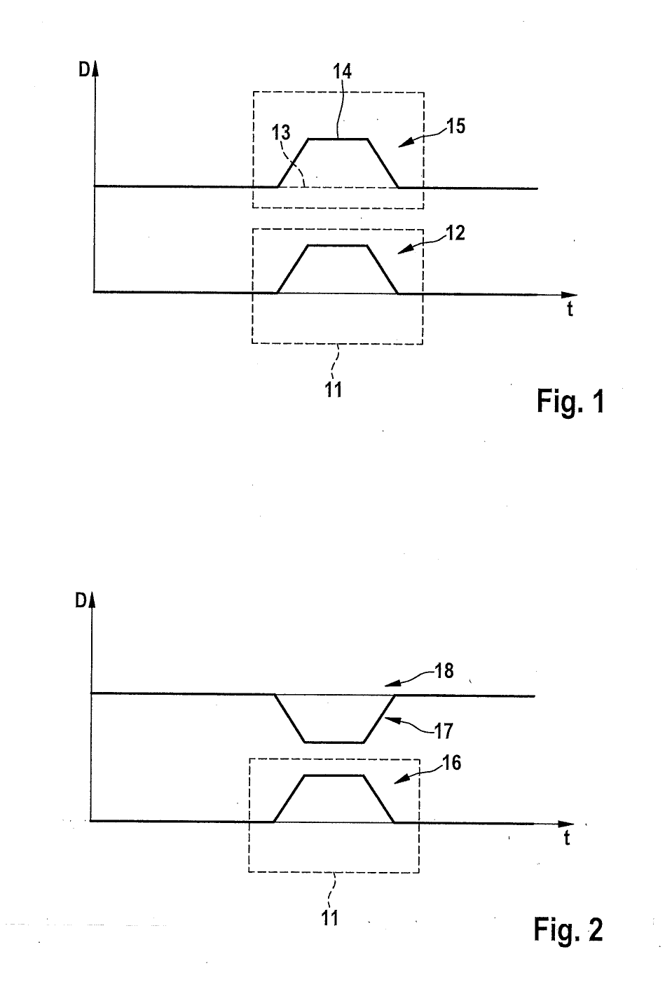

In FIG. 1, wheel torque (D) during the clutch start of a motor vehicle is illustrated over time (t) for a conventional method known from the related art. This is thus a D-t diagram. The box including reference numeral 11 marks the clutch start. In the area marked by the box, a braking wheel torque 12 is generated by the clutch start. Outside of the marked area, wheel torque 12 is zero in relation to the clutch start. The curve of the braking wheel torque of the service brake is shown by reference numeral 13. Outside of area 11 without a clutch start, but also in area 11 of the clutch start, the service brake causes a constant braking wheel torque. However, in the area in which the clutch start takes place, an increase 14 of the total braking effect, i.e., total braking wheel torque 15, occurs due to the clutch start. In summary, the clutch engagement results in starting the internal combustion engine at a wheel torque having a braking effect on the drive wheels. If the service brake is applied in addition in this driving situation in which the clutch start occurs, both wheel torques having a braking effect add up to a total braking wheel torque. For the passengers, this results in a comfort-reducing vehicle acceleration curve.

In FIG. 2, a D-t diagram of a motor vehicle is shown, the clutch start of which is carried out with the aid of one specific embodiment of the method according to the present invention. The disadvantage of the conventional method described in FIG. 1 does not occur in this case. The clutch start again takes place in area 11. In this area 11, which is again marked by a box, a braking torque 16 is produced on the drive wheels. This is equivalent to braking wheel torque 12 from the related art. In the same period of time in which the clutch torque is effective, the effect of the service brake is now reduced according to the present invention. The curve of corresponding wheel torque component 17 of the service brake is also shown in FIG. 2. The brake pressure of the service brake is thus reduced by the amount of the clutch torque during the clutch start precisely when the clutch start causes a braking wheel torque 16. Total braking wheel torque 18 thus retains the amount that the brake force of the brake would cause without the braking clutch torque, i.e., as in the areas outside of clutch start 11. In the method according to the present invention, excessive increase 14 of the total braking wheel torque may be counteracted, in that the torque of the service brake is reduced by the value which the clutch start causes as effective wheel torque by engaging the clutch. The value of the clutch torque having a braking effect is calculated by the clutch control and is transferred to the ABS or ESP control unit of the motor vehicle. One of these control units then coordinates the brake intervention. In the ideal case, the clutch start may consequently be compensated by reducing the braking torque, so that it is not noticeable to the passengers.

What is claimed is:

1. A method for controlling a clutch start after an engine stop coasting phase of a motor vehicle whose service brake is applied and whose braking system may be influenced by a clutch control with regard to a braking torque, comprising:
reducing the braking torque by a value of a clutch torque having a braking effect which the clutch start causes as an effective wheel torque by engaging the clutch.

2. The method as recited in claim 1, wherein the braking system is equipped with at least one of an ABS and an ESP system.

3. The method as recited in claim 1, further comprising:
calculating the value of the clutch torque having the braking effect by the clutch control; and
transferring the value of the clutch torque having the braking effect to a device which coordinates a brake intervention.

4. The method as recited in claim 3, wherein the device is at least one of an ABS control unit and an ESP control unit.

5. A computer program which carries out all steps of a method for controlling a clutch start after an engine stop coasting phase of a motor vehicle whose service brake is applied and whose braking system may be influenced by a clutch control with regard to a braking torque, the method comprising:
reducing the braking torque by a value of a clutch torque having a braking effect which the clutch start causes as an effective wheel torque by engaging the clutch, the reducing being performed when the computer program is run on one of a computing device and a control unit.

6. A data medium that stores a computer program which carries out all steps of a method for controlling a clutch start after an engine stop coasting phase of a motor vehicle whose service brake is applied and whose braking system may be influenced by a clutch control with regard to a braking torque, the method comprising:
reducing the braking torque by a value of a clutch torque having a braking effect which the clutch start causes as an effective wheel torque by engaging the clutch, the reducing being performed when the computer program is run on one of a computing device and a control unit.

7. A control unit which is designed for controlling a clutch start of a motor vehicle with the aid of a method for controlling a clutch start after an engine stop coasting phase of a motor vehicle whose service brake is applied and whose braking system may be influenced by a clutch control with regard to a braking torque, the method comprising:
reducing the braking torque by a value of a clutch torque having a braking effect which the clutch start causes as an effective wheel torque by engaging the clutch, the reducing being performed when the computer program is run on one of a computing device and a control unit.
